(19) United States
(12) Patent Application Publication
(10) Pub. No.: US 2019/0007745 A1
(43) Pub. Date: Jan. 3, 2019

(54) METHODS, SYSTEMS, AND MEDIA FOR PRESENTING NOTIFICATIONS ON ASSOCIATED DEVICES

(71) Applicant: Google Inc., Mountain View, CA (US)

(72) Inventors: Justin Lewis, South San Francisco, CA (US); Richard Rapp, Marina Del Rey, CA (US)

(21) Appl. No.: 15/639,582

(22) Filed: Jun. 30, 2017

(51) Int. Cl. H04N 21/488; H04N 21/431; H04L 29/08

(52) U.S. Cl. CPC H04N 21/4882; H04L 67/26; H04N 21/4316

(57) ABSTRACT

Methods, systems, and media for presenting notifications on associated devices are provided. In some implementations, the method comprises: receiving a selection of a media content item on a first user device; causing playback of the media content item to begin on a second user device associated with the first user device; detecting, on the first user device, an event; determining whether to present a notification of the event; in response to determining that the notification of the event is to be presented, generating a media stream that includes the notification; and transmitting the media stream and instructions for presenting the media stream from the first user device to the second user device, wherein the instructions cause the media stream to be presented by the second user device.

### TECHNICAL FIELD

The disclosed subject matter relates to methods, systems, and media for presenting notifications on associated devices.

### BACKGROUND

Users frequently begin viewing media content, such as music, videos, television programs, etc. on a first user device, such as a mobile phone or tablet computer, and want to transfer playback of the media content to a second user device, such as a television or speakers. In many cases, while the second user device is presenting the media content, the first user device may continue to receive messages or present reminders. However, a user viewing the media content on the second user device may not want to view notifications of received messages or reminders on the first user device while the user is paying attention to the media content being presented on the second user device.

Accordingly, it is desirable to provide methods, systems, and media for presenting notifications on associated devices.

### SUMMARY

Methods, systems, and media for presenting notifications on associated devices are provided.

In accordance with some implementations of the disclosed subject matter, a computer-implemented method for presenting notifications is provided, the method comprising: receiving a selection of a media content item on a first user device; causing playback of the media content item to begin on a second user device associated with the first user device; detecting, on the first user device, an event; determining whether to present a notification of the event; in response to determining that the notification of the event is to be presented, generating a media stream that includes the notification; and transmitting the media stream and instructions for presenting the media stream from the first user device to the second user device, wherein the instructions cause the media stream to be presented by the second user device.

In some implementations, detecting the event further comprises determining that a message has been received by the first user device.

In some implementations, the instructions cause the media stream to be inserted in a presentation queue of media content items to be presented by the second user device.

In some implementations, the method further comprises: determining that the notification is no longer to be presented; and, in response to determining that the notification is no longer to be presented, transmitting instructions from the first user device to the second user device to inhibit presentation of the media stream.

In some implementations, determining whether to present the notification of the event is based on an application executing on the first user device that is associated with the event.

In some implementations, the instructions for presenting the media stream cause the notification to be presented as an overlay superimposed on the media content item presented on the second user device.

In some implementations, the media content item is transmitted as a current media content stream and the instructions for presenting the media stream cause the media stream that includes the notification to be presented after the presentation of the current media content stream that includes the media content item.

In accordance with some implementations of the disclosed subject matter, a system for presenting notifications is provided, the system comprising a memory and a hardware processor that, when executing computer executable instructions stored in the memory, is configured to: receive a selection of a media content item on a first user device; cause playback of the media content item to begin on a second user device associated with the first user device; detect, on the first user device, an event; determine whether to present a notification of the event; in response to determining that the notification of the event is to be presented, generate a media stream that includes the notification; and transmit the media stream and instructions for presenting the media stream from the first user device to the second user device, wherein the instructions cause the media stream to be presented by the second user device.

In accordance with some implementations of the disclosed subject matter, a non-transitory computer-readable medium containing computer-executable instructions that, when executed by a processor, cause the processor to perform a method for presenting notifications is provided, the method comprising: receiving a selection of a media content item on a first user device; causing playback of the media content item to begin on a second user device associated with the first user device; detecting, on the first user device, an event; determining whether to present a notification of the event; in response to determining that the notification of the event is to be presented, generating a media stream that includes the notification; and transmitting the media stream and instructions for presenting the media stream from the first user device to the second user device, wherein the instructions cause the media stream to be presented by the second user device.

In accordance with some implementations of the disclosed subject matter, a system for presenting notifications is provided, the system comprising: means for receiving a selection of a media content item on a first user device; means for causing playback of the media content item to begin on a second user device associated with the first user device; means for detecting, on the first user device, an event; means for determining whether to present a notification of the event; means for generating a media stream that includes the notification in response to determining that the notification of the event is to be presented; and means for transmitting the media stream and instructions for presenting the media stream from the first user device to the second user device, wherein the instructions cause the media stream to be presented by the second user device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a user interface for presenting notifications on a second user device associated with a first user device in accordance with some implementations of the disclosed subject matter.

FIG. 2 shows a schematic diagram of an illustrative system suitable for implementation of mechanisms described herein for presenting notifications on associated devices in accordance with some implementations of the disclosed subject matter.

FIG. 3 shows a detailed example of hardware that can be used in a server and/or a user device of FIG. 2 in accordance with some implementations of the disclosed subject matter.

FIG. 4 shows an illustrative example of a process for presenting notifications in accordance with some implementations of the disclosed subject matter.

### DETAILED DESCRIPTION

In accordance with various implementations, mechanisms (which can include methods, systems, and media) for presenting notifications on associated devices are provided.

In some implementations, the mechanisms described herein can cause playback of a media content item to be transferred from a first user device to a second user device. For example, in some implementations, the mechanisms can cause the media content to be cast from the first user device (e.g., a mobile phone, a tablet computer, a wearable computer, and/or any other suitable type of user device) to the second user device (e.g., a television, a media receiver device, a display device, an audio receiver device, speakers, a headset, and/or any other suitable type of user device) in response to an input from a user of the first user device. In some implementations, the mechanisms can cast media content from the first user device to the second user device using any suitable techniques, such as transmitting an indication of a location of the media content from the first user device to the second user device, transmitting a media stream that includes the media content from the first user device to the second user device, and/or any other suitable techniques.

In some implementations, the mechanisms can detect an event on the first user device, such as receiving a message, a reminder, a notification from an application executing on the first user device, and/or any other suitable type of event. The mechanisms can then generate a media stream that includes a notification of the event and transmit the media stream from the first user device to the second user device for presentation on the second user device. For example, in some implementations, a notification that an email has been received on the first user device can be presented by the second user device. In some implementations, the notification of the event can include any suitable content and can be presented in any suitable manner. For example, in some implementations, the notification can include text indicating the event (e.g., “5 new emails,” and/or any other suitable text), any suitable images or icons, and/or any other suitable content. As another example, in some implementations, the notification can be presented with any suitable sound effect. As yet another example, in some implementations, the notification can be presented as a graphical overlay superimposed on the media content item being presented on the second user device.

Note that, in some implementations, the media content item can include any suitable type of media content. For example, in some implementations, the media content item can include video content, such as a video, a movie, a television program, live-streamed video content, a video chat, and/or any other suitable type of video content. As another example, in some implementations, the media content item can include audio content, such as music, an audio file, a radio program, live-streamed audio content, and/or any other suitable type of audio content. Additionally or alternatively, in some implementations, the media content item can be a media content item from a playlist or collection of media content items, such as a video in a playlist of videos, a song from a playlist of songs, and/or any other suitable type of playlist or collection of media content items. Additionally or alternatively, in some implementations, the media content item can be virtual reality content or augmented reality content being presented in a head-mountable device.

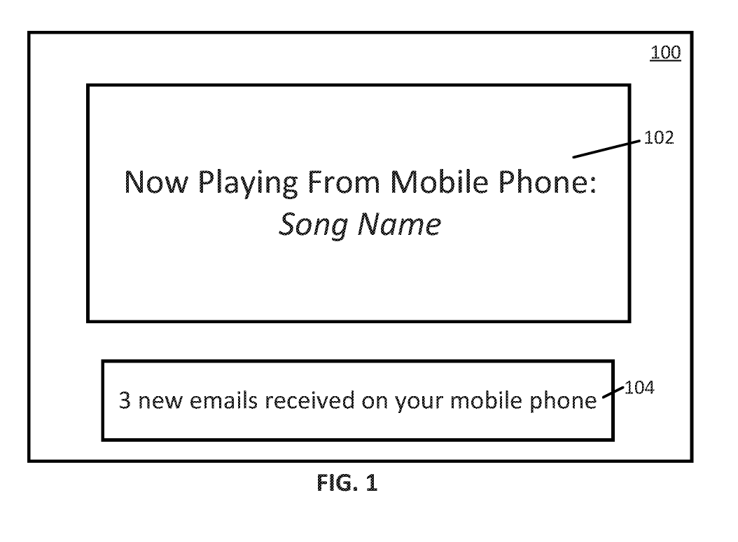

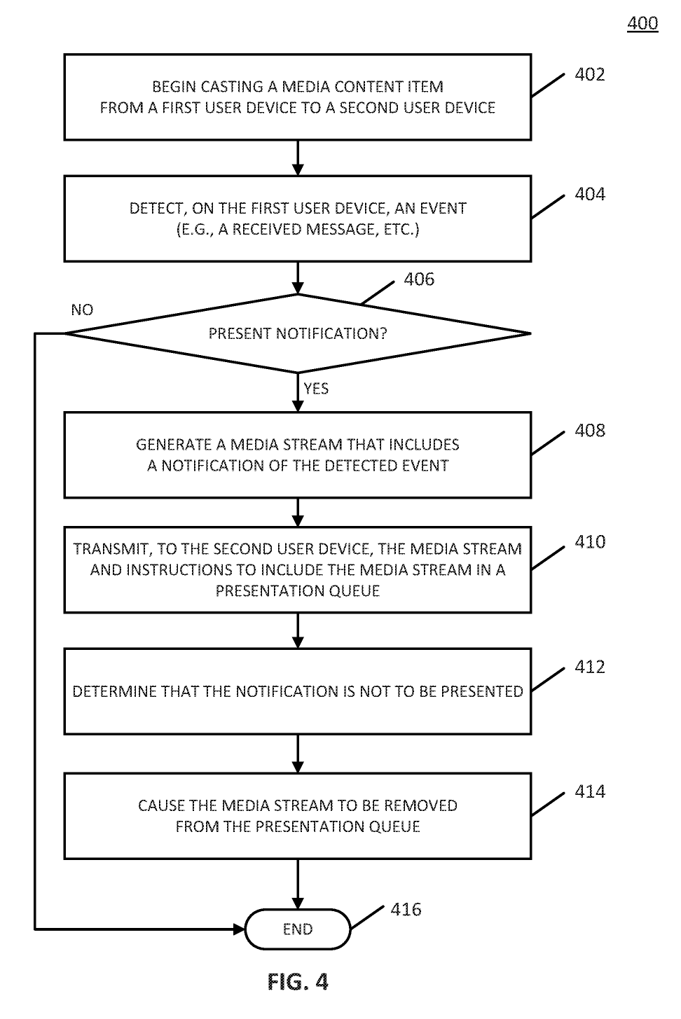

Turning to FIG. 1, an example 100 of a user interface for presenting notifications is shown in accordance with some implementations of the disclosed subject matter. In some implementations, user interface 100 can be presented on a second user device (e.g., a television, speakers, a projector, a desktop computer, and/or any other suitable type of user device) that is associated with a first user device (e.g., a mobile phone, a tablet computer, a wearable computer, and/or any other suitable type of user device). In some implementations, the first user device can cast media content 102 from the first user device to the second user device, for example, by directing the second user device to present media content 102, as described in more detail below in connection with FIG. 4. Additionally, in some implementations, user interface 100 can include a notification 104 that represents an event detected on the first user device.

In some implementations, media content 102 can be any suitable type of media content. For example, in some implementations, media content 102 can include music, a music item from a playlist of music items, a video, a video item from a playlist of video items, a television program, live-streamed video content or audio content, and/or any other suitable type of media content. In some implementations, media content 102 can be presented in any suitable manner. For example, in instances where media content 102 includes video content, the video content can be presented within a video player window that includes any suitable video playback controls (e.g., a pause control, a rewind control, a fast-forward control, a volume control, and/or any other suitable playback controls). As another example, in instances where media content 102 is audio content (e.g., a song or other audio content item), user interface 100 can include any suitable controls for manipulating playback of audio content (e.g., a pause control, a rewind control, a fast-forward control, a volume control, and/or any other suitable playback controls). Note that, in some implementations, media content 102 can be include audio content that is presented on a user device without a display screen, such as speakers. In some such implementations, media content 102 can be presented without a user interface on the user device.

In some implementations, notification 104 can be a notification of any suitable event detected on a first user device that is casting media content 102 to the second user device. For example, in some implementations, notification 104 can indicate email messages or text messages received on the user device, a notification from an application executing on the first user device, a reminder of an event stored on a calendar of the first user device, and/or any other suitable type of notification. In some implementations, notification 104 can be presented in any suitable manner. For example, in some implementations, notification 104 can be presented within a pop-up window that appears in user interface 100. As another example, in some implementations, notification 104 can be presented as a graphical overlay superimposed on media content 102 and rendered with any suitable transparency or blending effects. As yet another example, in some implementations, notification 104 can be presented in connection with an audible tone. Note that, in some implementations, in instances where media content 102 is being presented on a user device without a display, notification 104 can be presented as an audible notification, for example, as a message read out loud.

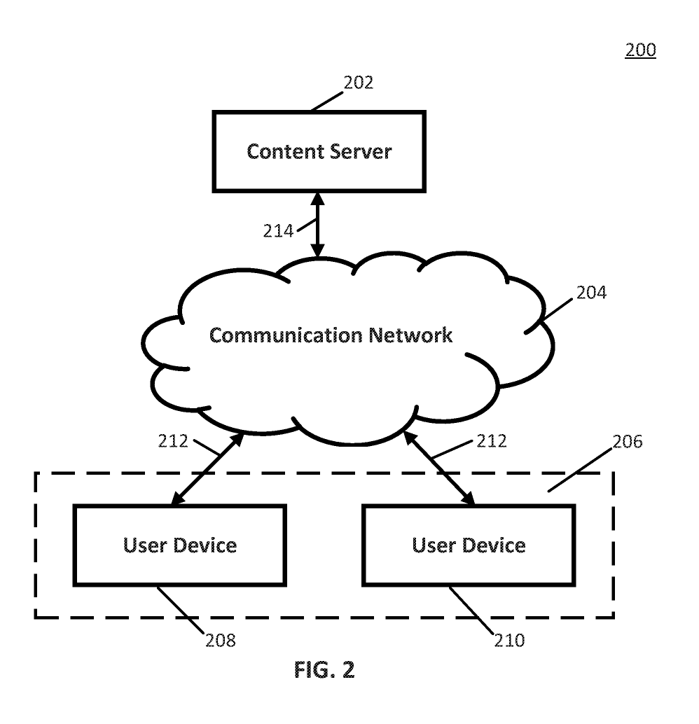

Turning to FIG. 2, an illustrative example 200 of hardware for presenting notifications that can be used in accordance with some implementations of the disclosed subject matter is shown. As illustrated, hardware 200 can include one or more servers such as a content server 202, a communication network 204, and/or one or more user devices 206, such as user devices 208 and 210.

In some implementations, content server 202 can be any suitable server for storing content and transmitting the content to a user device for presentation, and/or performing any other suitable function(s). For example, in some implementations, content server 202 can be a server that transmits media content to user device 206 via communication network 204. In some implementations, the content on content server 202 can be any suitable content, such as video content, audio content, movies, television programs, live-streamed content, audiobooks, and/or any other suitable type of content. In some implementations, content server 202 can be omitted.

Communication network 204 can be any suitable combination of one or more wired and/or wireless networks in some implementations. For example, communication network 204 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 206 can be connected by one or more communications links 212 to communication network 204 that can be linked via one or more communications links (e.g., communications link 214) to content server 202. Communications links 212 and/or 214 can be any communications links suitable for communicating data among user devices 206 and server 202 such as network links, dial-up links, wireless links, hard-wired links, any other suitable communications links, or any suitable combination of such links.

In some implementations, user devices 206 can include one or more computing devices suitable for storing media content items, viewing media content items, transferring playback of a media content item to an associated device (e.g., a digital media receiver, a television, speakers, and/or any other suitable type of user device), and/or any other suitable functions. For example, in some implementations, user devices 206 can be implemented as a mobile device, such as a smartphone, mobile phone, a tablet computer, a wearable computer, a laptop computer, a vehicle (e.g., a car, a boat, an airplane, or any other suitable vehicle) entertainment system, a portable media player, and/or any other suitable mobile device. As another example, in some implementations, user devices 206 can be implemented as a non-mobile device such as a desktop computer, a set-top box, a television, a streaming media player, a game console, and/or any other suitable non-mobile device.

In a more particular example, user device 206 can be a display device that includes hardware and/or software for presenting media received from one or more sources of media content. For example, user device 206 can include a television, a smart television, a monitor, a set-top box, an audio video (AV) receiver, any other suitable media playback device and/or any suitable combination thereof. More particularly, user device 206 can include a display, speakers, hardware and/or software for rendering media content such as analog and/or digital video and/or audio data, a power supply, etc. User device 206 can, in some implementations, include various input ports for receiving video and/or audio data from various sources. Such input ports can include one or more HDMI ports, one or more component video ports, one or more composite video ports, one or more USB ports, one or more S-Video ports, one or more TOSLINK ports, one or more coaxial ports, one or more Ethernet ports (whether wired or wireless), etc.

In another more particular example, user device 206 can be any suitable device that can receive an audio signal and output the audio signal (potentially through one or more intermediate devices) to one or more speakers. For example, user device 206 can be an audio video (AV) receiver, a speaker, an amplifier, an audio switch, an HDMI switch, any other suitable audio system and/or any suitable combination thereof. More particularly, user device 206 can include, speakers, hardware and/or software for rendering media content such as analog and/or digital audio and/or video data, a power supply, etc. User device 206 can include various input ports for receiving audio and/or video data from various sources. Such input ports can include one or more HDMI ports, one or more component video ports, one or more composite video ports, one or more USB ports, one or more S-Video ports, one or more TOSLINK ports, one or more coaxial ports, one or more Ethernet ports (whether wired or wireless), etc. Additionally or alternatively, in some implementations, user device 206 can be configured to receive an audio signal over any suitable wireless connection, such as over a connection to a local area network (e.g., via a connection that complies with one of the IEEE 802.11x family of protocols which are sometimes referred to as Wi-Fi connections), or a wireless connection between external sound system 106 and computing device 102, such as an ad hoc wireless network connection, a short-range wireless communication protocol (e.g., Bluetooth, Bluetooth Low Energy, Wireless USB, etc.), etc.

Although content server 202 is illustrated as a single device, the functions performed by content server 202 can be performed using any suitable number of devices in some implementations. For example, in some implementations, multiple devices can be used to implement the functions performed by content server 202.

Although two user devices 208 and 210 are shown in FIG. 2, any suitable number of user devices, and/or any suitable types of user devices, can be used in some implementations.

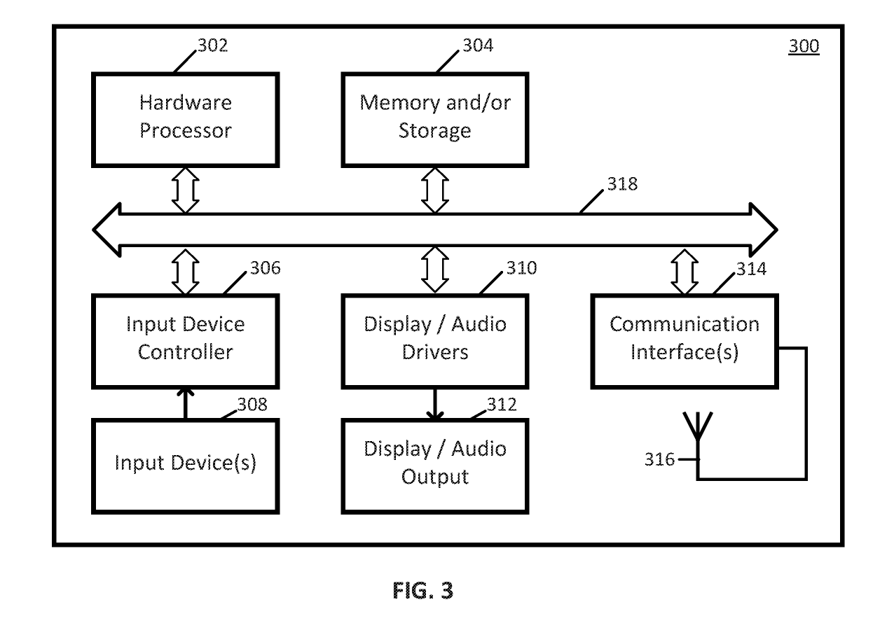

Content server 202 and user devices 206 can be implemented using any suitable hardware in some implementations. For example, in some implementations, devices 202 and 206 can be implemented using any suitable general purpose computer or special purpose computer. For example, a server may be implemented using a special purpose computer. Any such general purpose computer or special purpose computer can include any suitable hardware. For example, as illustrated in example hardware 300 of FIG. 3, such hardware can include hardware processor 302, memory and/or storage 304, an input device controller 306, an input device 308, display/audio drivers 310, display and audio output circuitry 312, communication interface(s) 314, an antenna 316, and a bus 318.

Hardware processor 302 can include any suitable hardware processor, such as a microprocessor, a micro-controller, digital signal processor(s), dedicated logic, and/or any other suitable circuitry for controlling the functioning of a general purpose computer or a special purpose computer in some implementations. In some implementations, hardware processor 302 can be controlled by a server program stored in memory and/or storage 304 of a server (e.g., such as content server 202). For example, the server program can cause hardware processor 302 of content server 202 to transmit a media content item to a user device, and/or perform any other suitable functions. In some implementations, hardware processor 302 can be controlled by a computer program stored in memory and/or storage 304 of user device 206. For example, the computer program can cause hardware processor 302 of user device 206 to transmit data corresponding to a media content item to an associated device, detect an event on user device 206, generate a media stream that includes a notification of the detected event, transmit the media stream to the associated device, and/or perform any other suitable functions.

Memory and/or storage 304 can be any suitable memory and/or storage for storing programs, data, media content, advertisements, and/or any other suitable information in some implementations. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some implementations. For example, input device controller 306 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device. In another example, input device controller 306 can be circuitry for receiving input from a head-mountable device (e.g., for presenting virtual reality content or augmented reality content).

Display/audio drivers 310 can be any suitable circuitry for controlling and driving output to one or more display/audio output devices 312 in some implementations. For example, display/audio drivers 310 can be circuitry for driving a touchscreen, a flat-panel display, a cathode ray tube display, a projector, a speaker or speakers, and/or any other suitable display and/or presentation devices.

Communication interface(s) 314 can be any suitable circuitry for interfacing with one or more communication networks, such as network 204 as shown in FIG. 2. For example, interface(s) 314 can include network interface card circuitry, wireless communication circuitry, and/or any other suitable type of communication network circuitry.

Antenna 316 can be any suitable one or more antennas for wirelessly communicating with a communication network (e.g., communication network 204) in some implementations. In some implementations, antenna 316 can be omitted.

Bus 318 can be any suitable mechanism for communicating between two or more components 302, 304, 306, 310, and 314 in some implementations.

Any other suitable components can be included in hardware 300 in accordance with some implementations.

Turning to FIG. 4, an example 400 of a process for presenting notifications on associated devices is shown in accordance with some implementations of the disclosed subject matter. In some implementations, blocks of process 400 can be executed on a first user device which casts media content to an associated second user device.

In some implementations, process 400 can begin by casting a media content item from the first user device to the second user device at 402. In some implementations, the media content item can be selected for presentation by a user of the first user device, for example, via a user interface presented on the first user device. In some implementations, process 400 can begin casting the media content item in response to any suitable information or event. For example, in some implementations, process 400 can receive an input from a user of the first user device that indicates that the user wants to transfer playback of the media content item from the first user device to the second user device. As a more particular example, in some implementations, the first user device can detect that the user has selected a particular icon or other selectable input on the first user device that initiates the playback transfer to the second user device. In some implementations, process 400 can transfer playback of the media content item in any suitable manner. For example, in some implementations, process 400 can transmit an instruction from the first user device to the second user device that instructs the second user device to open a particular application associated with the media content item (e.g., a media player application, and/or any other suitable type of application). As another example, in some implementations, process 400 can transmit a location of the media content item, such as a Uniform Resource Locator (URL) or other location. As yet another example, in some implementations, process 400 can transmit a media stream that includes the media content item from the first user device to the second user device over a local communication network (e.g., a BLUETOOTH network, a local WiFi network, and/or any other suitable type of network).

Note that, in some implementations, the first user device and the second user device can be associated with each other or paired in any suitable manner. For example, in some implementations, the first user device and the second user device can both be connected to a local communication network, such as a WiFi network, a BLUETOOTH network, and/or any other suitable network. As another example, in some implementations, the first user device and the second user device can both be authenticated to a user account associated with a user of the first user device and/or the second user device. In some such implementations, the user associated with the user account may have indicated that the first user device and the second user device are to be paired and/or associated with each other.

Process 400 can detect an event on the first user device at 404. In some implementations, the detected event can be any suitable type of event, such as that a message (e.g., an email, a text message, an instant message, and/or any other suitable type of event) has been received on the first user device, that a reminder (e.g., of an event indicated on a calendar application, and/or any other suitable type of reminder) is to be presented, a notification associated with an application executing on the first user device is to be presented, and/or any other suitable type of event. In some implementations, the detected event can be associated with any suitable application executing on the first user device, such as an email client, an instant messaging application, a messaging interface, an application associated with a social networking service, a news collating application, and/or any other suitable type of application.

At 406, process 400 can determine whether to present a notification associated with the detected event. Process 400 can determine whether to present the notification based on any information and/or criteria. For example, in some implementations, process 400 can determine that the notification is to be presented if the event is associated with a particular application executing on the first user device (e.g., associated with an email client, associated with a particular social networking service, and/or any other suitable type of application). As another example, in some implementations, process 400 can determine that the notification is to be presented if the event corresponds to a message received from a particular message sender (e.g., a particular contact associated with a user of the first user device, and/or any other suitable user). In some implementations, criteria used to determine whether to present the notification can be set by a user of the first user device, for example, in a settings interface.

If, at 406, process 400 determines that the notification is not to be presented (“no” at 406), process 400 can terminate at 416.

If, at 406, process 400 determine that the notification is to be presented (“yes” at 406), process 400 can generate a media stream that includes the notification of the detected event at 408. In some implementations, process 400 can generate a notification of the detected event that includes any suitable content. For example, in some implementations, the generated notification can include text that indicates the event (e.g., “5 new emails,” “text message from Mom,” and/or any other suitable text). As another example, in some implementations, the generated notification can include an image or icon that represents an application associated with the detected event. As yet another example, in some implementations, the generated notification can include any other suitable content, such as videos, images, animations, links, and/or any other suitable type of content. In some implementations, process 400 can generate the media stream that includes the notification. For example, in some implementations, the media stream can include a generated image that corresponds to the notification. As another example, in some implementations, the media stream can be a video stream that includes an image of the notification appearing. As yet another example, in some implementations, the media stream can include any suitable sound effects associated with presentation of the notification. As a specific example, in some implementations, the sound effect associated with presentation of the notification can be a sound effect that is specified on the first user device as corresponding to events of the type of event corresponding to the detected event (e.g., a first sound effect corresponding to received messages associated with an email client, a second sound effect corresponding to push notifications associated with a particular social networking service, and/or any other suitable sound effects).

Process 400 can transmit the media stream and instructions to present the media stream to the second user device at 410. In some implementations, the media stream and the instructions can be transmitted in any suitable manner, for example, via a communication network that the first user device and the second user device are both connected to, such as a BLUETOOTH network, a WiFi network, and/or any other suitable network.

In some implementations, the instructions can cause the second user device to insert the media stream into a presentation queue of media content items to be presented on the second user device. For example, in some implementations, the instructions can cause the media stream to be inserted into the presentation queue after a media content item that is currently being presented on the second user device. As another example, in some implementations, the instructions can cause the media stream to be presented concurrently with a media content item that is currently being presented on the second user device. Note that, in some implementations, process 400 can determine whether the media stream is to be presented concurrently with a media content item that is currently being presented or inserted into the presentation queue after the media content item based on any suitable information. For example, in some implementations, the determination can be made based on a type of content currently being presented. As a more particular example, in instances where the media content item currently being presented is audio content presented and where the second user device include a display screen, process 400 can determine that the media stream that includes the notification is to be concurrently presented with the media content item. In some such implementations, sound effects associated with the notification can be disabled. As another more particular example, in instances where the media content item currently being presented is a video of a playlist of videos, process 400 can determine that the media stream that includes the notification is to be presented after the currently presented video in the playlist of videos, prior to presentation of the next video in the playlist of videos. As another example, in some implementations, the determination can be made based on the notification included in the media stream. As a more particular example, in some implementations, process 400 can determine that media streams that include notifications associated with particular applications (e.g., an email client, a messaging interface, and/or any other suitable applications) are to be concurrently presented with media content item currently being presented, and that media streams that include notifications associated with other applications (e.g., a particular social networking service application, and/or any other suitable application) are to be presented after presentation of the media content item has finished.

In some implementations, the instructions can indicate a visual manner in which the notification is to be presented on the second user device. For example, in some implementations, the instructions can cause the second user device to render the notification as a graphical overlay superimposed on visual content of currently presented media content (e.g., a video that is currently being presented, an audio player window that includes controls for manipulating playback of currently played audio content, and/or any other suitable type of visual content). As a more particular example, in some implementations, the instructions can cause the graphical overlay to be rendered as three-dimensional content. Additionally or alternatively, in some implementations, the instructions can include parameters for any suitable visual effects, such as colors, transparency values, shading effects, blending effects, and/or any other suitable visual presentation parameters.

Note that, in some implementations, the instructions can cause the second user device to resume presenting any suitable media content items after presenting the media stream corresponding to the notification. For example, in instances where the instructions cause the media stream to be inserted into a presentation queue of videos in a playlist of videos, the instructions can cause the second user device to finish presenting a first video, present the media stream corresponding to the notification, and then present a second video in the playlist of videos. Additionally, note that, in some implementations, the instructions can cause the second user device to pause presentation of a media content item that is currently being presented, present the media stream corresponding to the notification, and then resume presenting the media content item.

In some implementations, process 400 can determine that the notification is not to be presented at 412. For example, in some implementations, process 400 can determine that the user has viewed the notification on the first user device or has opened an application associated with the notification on the first user device. As a more particular example, in instances where the notification indicates that one or more emails have been received by an email client executing on the first user device, process 400 can determine that the user has opened the email client on the first user device, read at least one of the one or more emails, swiped the notification on the first user device, and/or performed any other suitable action. As another example, in some implementations, process 400 can determine that the notification has expired based on any suitable information. As a more particular example, process 400 can determine that more than a predetermined duration of time (e.g., more than ten seconds, more than a minute, more than five minutes, and/or any other suitable duration of time) has elapsed since the event was detected.

In some implementations, in response to determining that the notification is not to be presented, process 400 can cause the media stream that includes the notification to be removed from the presentation queue of the second user device and/or inhibited from presentation by the second user device at 414. For example, in some implementations, process 400 can transmit an instruction to the second user device that identifies the media stream and instructs the second user device to discard the media stream and/or not present the media stream.

Process 400 can terminate at block 416.

In some implementations, at least some of the above described blocks of the process of FIG. 4 can be executed or performed in any order or sequence not limited to the order and sequence shown in and described in connection with the figure. Also, some of the above blocks of FIG. 4 can be executed or performed substantially simultaneously where appropriate or in parallel to reduce latency and processing times. Additionally or alternatively, some of the above described blocks of the process of FIG. 4 can be omitted.

In some implementations, any suitable computer readable media can be used for storing instructions for performing the functions and/or processes herein. For example, in some implementations, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personal information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for presenting notifications on associated devices are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

1. A method for presenting notifications, the method comprising:
receiving a selection of a media content item on a first user device;
causing playback of the media content item to begin on a second user device associated with the first user device, wherein the first user device and the second user device have been authenticated to a user account;
detecting, on the first user device, an event;
determining whether to present a notification of the event;
in response to determining that the notification of the event is to be presented, generating a media stream that includes the notification; and
transmitting the media stream and instructions for presenting the media stream from the first user device to the second user device, wherein the instructions cause the media stream to be rendered by the second user device in which the notification is presented as a graphical overlay that is superimposed over at least a portion of the media content item being presented by the second user device.

2. The method of claim 1, wherein detecting the event further comprises determining that a message has been received by the first user device.

3. The method of claim 1, wherein the instructions cause the media stream to be inserted in a presentation queue of media content items to be presented by the second user device.

4. The method of claim 1, further comprising:
determining that the notification is no longer to be presented; and
in response to determining that the notification is no longer to be presented, transmitting instructions from the first user device to the second user device to inhibit presentation of the media stream.

5. The method of claim 1, wherein determining whether to present the notification of the event is based on an application executing on the first user device that is associated with the event.

6. (canceled)

7. The method of claim 1, wherein the media content item is transmitted as a current media content stream and wherein the instructions for presenting the media stream cause the media stream that includes the notification to be presented after the presentation of the current media content stream that includes the media content item.

8. A system for presenting notifications, the system comprising:
a memory; and
a hardware processor that, when executing computer executable instructions stored in the memory, is configured to:
receive a selection of a media content item on a first user device;
cause playback of the media content item to begin on a second user device associated with the first user device, wherein the first user device and the second user device have been authenticated to a user account;
detect, on the first user device, an event;
determine whether to present a notification of the event;
in response to determining that the notification of the event is to be presented, generate a media stream that includes the notification; and
transmit the media stream and instructions for presenting the media stream from the first user device to the second user device, wherein the instructions cause the media stream to be rendered by the second user device in which the notification is presented as a graphical overlay that is superimposed over at least a portion of the media content item being presented by the second user device.

9. The system of claim 8, wherein detecting the event further comprises determining that a message has been received by the first user device.

10. The system of claim 8, wherein the instructions cause the media stream to be inserted in a presentation queue of media content items to be presented by the second user device.

11. The system of claim 8, wherein the hardware processor is further configured to:
determine that the notification is no longer to be presented; and
in response to determining that the notification is no longer to be presented, transmit instructions from the first user device to the second user device to inhibit presentation of the media stream.

12. The system of claim 8, wherein determining whether to present the notification of the event is based on an application executing on the first user device that is associated with the event.

13. (canceled)

14. The system of claim 8, wherein the media content item is transmitted as a current media content stream and wherein the instructions for presenting the media stream cause the media stream that includes the notification to be presented after the presentation of the current media content stream that includes the media content item.

15. A non-transitory computer-readable medium containing computer executable instructions that, when executed by a processor, cause the processor to perform a method for presenting notifications, the method comprising:
receiving a selection of a media content item on a first user device;
causing playback of the media content item to begin on a second user device associated with the first user device, wherein the first user device and the second user device have been authenticated to a user account;
detecting, on the first user device, an event;
determining whether to present a notification of the event;
in response to determining that the notification of the event is to be presented, generating a media stream that includes the notification; and
transmitting the media stream and instructions for presenting the media stream from the first user device to the second user device, wherein the instructions cause the media stream to be rendered by the second user device in which the notification is presented as a graphical overlay that is superimposed over at least a portion of the media content item being presented by the second user device.

16. The non-transitory computer-readable medium of claim 15, wherein detecting the event further comprises determining that a message has been received by the first user device.

17. The non-transitory computer-readable medium of claim 15, wherein the instructions cause the media stream to be inserted in a presentation queue of media content items to be presented by the second user device.

18. The non-transitory computer-readable medium of claim 15, wherein the method further comprises:
determining that the notification is no longer to be presented; and
in response to determining that the notification is no longer to be presented, transmitting instructions from the first user device to the second user device to inhibit presentation of the media stream.

19. The non-transitory computer-readable medium of claim 15, wherein determining whether to present the notification of the event is based on an application executing on the first user device that is associated with the event.

20. (canceled)

21. The non-transitory computer-readable medium of claim 15, wherein the media content item is transmitted as a current media content stream and wherein the instructions for presenting the media stream cause the media stream that includes the notification to be presented after the presentation of the current media content stream that includes the media content item.
